(19) United States
(12) Patent Application Publication
(10) Pub. No.: US 2011/0048944 A1
(43) Pub. Date: Mar. 3, 2011

(54) Measuring Device for Determining NH3

(75) Inventor: Sara Rentmeister, Buchenbach (DE)

(73) Assignee: Testo AG, Lenzkirch (DE)

(21) Appl. No.: 12/551,199

(22) Filed: Aug. 31, 2009

(51) Int. Cl. G01N 27/26

(52) U.S. Cl. 204/424; 204/431

(57) ABSTRACT

In a device (1) for determining the NH₃ content of a gas that is being measured, a first electrochemical gas sensor (2) and a second electrochemical gas sensors (3), which are set up for detection of the content of NO and/or NO₂ and/or NOₓ in the gas that is being measured are provided, where the gas being measured flows through the device and a converter (9) for catalytic conversion of NH₃ to NOₓ is arranged in front of the second electrochemical gas sensor (3) in the direction of flow of the measured gas stream (4), while the first electrochemical gas sensor (2) is brought into contact with the unaltered gas (FIG. 1).

The invention concerns a device for determination of the NH₃ content in a gas. A device and a method for remote measurement of waste gases, in which a light source emits IR radiation with a plurality of predetermined wavelengths and in which the device calculates the ratio of the absorption by the gas in two wavelengths, is known from WO98/37405 A1. However, the proposed determination of NH₃ by means of a laser in general requires high equipment expenditure.

The invention is based on the task of making available a device that enables determination of low concentrations of NH₃ that is as free as possible of cross sensitivity.

To solve this task it is provided that the device for determination of the NH₃ content in a gas have at least two electrochemical gas sensors, which are each sensitive to NO and/or NO₂ and/or NOₓ, and that a converter be provided that supports the oxidation of NH₃ to NO and/or NO₂, where one of the electrochemical gas sensors is brought into direct contact with a portion of the gas that is being measured and the other electrochemical gas sensor is brought into contact with a portion of the gas being measured, which has passed through the converter. Through the direct contact it is advantageously achieved that the gas being measured reaches the first electrochemical gas sensor in an essentially unaltered state, in particular without catalytic conversion. With that it is advantageously achieved that the first electrochemical gas sensor detects the NOₓ, thus NO and/or NO₂, that is present in the gas, while the other, thus the second electrochemical gas sensor, detects the sum of the NOₓ present in the gas and the NH₃ that has been oxidized or converted in the converter. Thus, the amount of NOₓ deriving from the NH₃ can be determined by subtraction. For example, a catalyst or a catalytic filter or a general element operating by a catalytic principle is used as the converter. It is advantageous with the invention that cross sensitivities, which arise in the use of electrochemical gas sensors for NH₃ in many applications, are suppressed or avoided.

It can be provided in accordance with one embodiment of the invention that the electrochemical gas sensors have an amperometric cell. It is advantageous in this case that the amperometric cell provides an electric signal that can be easily evaluated.

Alternatively or in addition it can be provided that the electrochemical gas sensors have an electrolyte. Liquid electrolytes and/or solid electrolytes can be used here. Thus, gas sensors that can be made at low cost can be used in the invention.

An especially precise and reliable determination of the NH₃ content is enabled when the electrochemical gas sensors are identically made.

In one embodiment of the invention it can be provided that the gas that is being measured is conducted as a gas stream to the gas sensors. This can be achieved, for example, by a tube and/or hose arrangement in which the gas is conducted to the gas sensors and/or conducted away from the gas sensors.

It is especially favorable here if the gas is delivered by a pump or a conveying means.

One embodiment of the invention can provide that the gas sensors are arranged in succession in the stream of gas being measured, and the converter is arranged between the gas sensors. It is advantageous in this case that the volume flow of the gas is the same at the first electrochemical gas sensor as the volume flow at the other, thus the second, electrochemical gas sensor, without additional means.

Looking at the reactions at the gas sensors, in this case the same amount of gas being measured first reaches the one electrochemical gas sensor and then the other electrochemical gas sensor.

Alternatively or in addition it can be provided that the gas stream being measured is divided into at least two partial streams and in each case a gas sensor is arranged in a partial stream, and the converter is arranged in one partial stream in the direction of flow before the gas sensor.

An easily produced embodiment can provide that the converter has a semiconductor material.

For reliable, reproducible operation of the device it can be provided that the converter can be heated to a predetermined constant temperature.

For example, it can be provided that the predetermined temperature lies between 300° C. and 700° C.

The favorable conditions for conversion of NH₃ to NO and/or NO₂ in the converter are achieved if the converter has or contains Pt, thus platinum, Pd, thus palladium, Rh, thus rhodium, or another metal of the platinum group, for example as alloy or in pure form.

Good conditions for use and/or a broad area of use are achieved if the device is portable and/or designed as a hand-held device. For this the device can be designed to operate, for example, on a storage battery, a battery and/or integrated and/or external power supply.

Provided the converter has high efficiency and converts (almost) exclusively NH₃ to NO, or, with a different converter, NH₂, a sensor element that is sensitive for NO or NO₂ is already sufficient.

To improve the measurement precision and/or to increase the reliability it can be provided that each gas sensor has a first electrochemical sensor element that is sensitive for NO and a second electrosensor element that is sensitive for NO₂. It is advantageous in this case that means for stabilizing thermodynamic equilibrium, in which a certain mixture ratio of NO to NO₂ is converted in the converter, can be omitted.

It is especially favorable in this case for the first sensor element to be arranged in the direction of flow of the measured gas stream in front of a second sensor element. However, measurement precisions and/or reliabilities that are already sufficient for many applications can be achieved with the reverse arrangement.

One design of the invention can provide that each gas sensor has an electrochemical sensor element, in which an electrochemical sensor element that is sensitive for NO and an electrochemical sensor element that is sensitive for NO₂ are integrated. It is advantageous in this case that a compact sensor element is made available for the gas sensors, with which the fraction of NOₓ in the measured gas is determinable or can be determined.

The invention will now be described in more detail by means of two embodiment examples, but it is not limited to these embodiment examples. Other embodiment examples result, for one skilled in the art, through the combination of the characteristics of the claims with each other and/or with the characteristics of the embodiment examples.

Here:

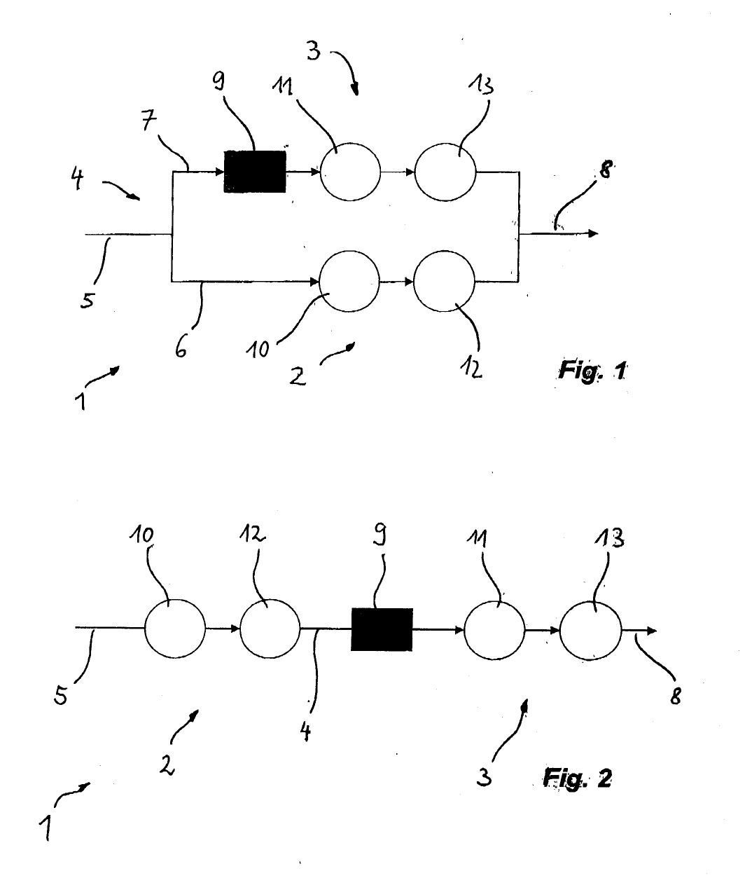

FIG. 1 shows a device in accordance with the invention with parallel arrangement of the electrochemical gas sensors,

and

FIG. 2 shows a device in accordance with the invention with series arrangement of the electrochemical gas sensors*. *[Translator's note: Figures are not provided.]

FIG. 1 shows a schematic sketch of a device (1) for determination of the NH₃ content of a gas that is being measured.

The device 1 has two electrochemical gas sensors 2 and 3. The gas is conducted to the electrochemical gas sensors 2 and 3 via a gas stream 4 (indicated by arrows), which arrives at device 1 via an inlet 5 and is then divided into a first partial stream 6 and a second partial stream 7, which go to the first electrochemical gas sensor 2 or the second electrochemical gas sensor [3].

While the first partial stream 6 of the gas goes directly to the first electrochemical gas sensor 2, a converter 9, through which the second partial stream 7 of the gas stream 4 is conducted, is arranged in the direction of flow in front of the second electrochemical gas sensor 3.

The converter 9 is thus designed so that NH₃ in the gas or a certain portion thereof is catalytically converted to NO and/or NO₂.

It can be provided that by stabilizing the temperature of converter 9 to a value that is predetermined and that lies between 300° C. and 700° C., a constant mixture ratio between the reaction products NO and NO₂ can be established.

The second partial stream 7 of the gas, after leaving converter 9, is conducted to the second electrochemical gas sensor 3, which thus detects the sum of the NO in the gas stream in front of the converter 9 and the NOₓ generated by conversion in converter 9.

The first electrochemical gas sensor 2, which does not have a connected converter 9, on the other hand detects only the amount of NO contained in the gas stream 4 from the start.

After leaving the electrochemical gas sensors 2 and 3 the gas stream 4 is conducted out of device 1 via an outlet 8.

The means of conveyance, for example a pump, for conveying the gas stream 4 are not shown in FIG. 1 for clarity. Preferably, these means are arranged in the direction of gas flow of the gas stream 4 behind the electrochemical gas sensors 2 and 3.

Each electrochemical gas sensor 2 and 3 has a first electrochemical sensor element 10 and 11, which is set up for the detection of NO and thus is sensitive for NO. Each electrochemical gas sensor 2 and 3 also has a second electrochemical sensor element 12 and 13 that is set up for the detection of NO₂ and thus is sensitive for NO₂.

The electrochemical sensor elements 10, 11, 12 and 13 each have an amperometric cell with a liquid electrolyte, which is chosen in correspondence with the desired sensitivity for NO or NO₂.

It proved to be a good idea to arrange the first electrochemical sensor elements 10 and 11 in the direction of flow of the gas stream 4 in front of the second electrochemical sensor elements 12 and 13. A reverse arrangement is realized in other embodiments.

The device 1 for determination of the NH₃ content of a gas shown in a schematic drawing in FIG. 2 differs from the one in FIG. 1 in that the gas stream 4 of the gas being measured is conducted undivided between the inlet 5 and the outlet 8.

The first electrochemical gas sensor 2 and the second electrochemical gas sensor 3 are thus arranged in succession in a series arrangement in the direction of flow of the gas stream 4.

The gas thus goes first through inlet 5 to the first electrochemical gas sensor 2 and is brought into direct contact with it. The electrochemical gas sensor 2 has a first electrochemical sensor element 10 that is sensitive for NO and a second electrochemical sensor element 12 that is sensitive for NO₂.

After leaving the electrochemical gas sensor 2 the gas in the gas stream 4, which is indicated in the schematic drawing by arrows, is conducted to a converter 9, which is designed the same as the converter 9 in FIG. 1.

In this converter 9 the NH₃ in the gas is converted to NO or NO₂ completely or in a certain amount.

The gas altered in this way, after leaving converter 9, is conducted to the second electrochemical gas sensor 3, which again has a first electrochemical sensor element 11 for detection of the amount of NO and a second electrochemical sensor element 13 for the determination of the amount of NO₂.

By processing the signals from the electrochemical gas sensors 2 and 3 the amount of NH₃ in the original gas can thus be calculated.

After passing through the electrochemical sensor elements 11 and 13 in the second electrochemical gas sensor 3 the gas stream 4 is discharged from device 1 through an outlet 8.

A means of conveyance, not shown, is provided for driving or conveying the gas stream 4 in device 1, as already described in FIG. 1.

The devices 1 in accordance with FIGS. 1 and 2 are each designed as portable devices and, in particular, also contain evaluation means (not shown) for the sensor signals of the electrochemical gas sensors 2 and 3 and indicator means for the calculated and/or measured values of the NH₃ content in the gas conducted through inlet 5.

In other embodiment examples the first electrochemical sensor element 10 and the second electrochemical sensor element 12 of the first gas sensor or the first electrochemical sensor element 11 and the second electrochemical sensor element 13 of the second gas sensor can each be integrated into an electrochemical sensor element that is sensitive for NOₓ.

A first electrochemical gas sensor and a second electrochemical gas sensor 3, which are set up for detection of NO and/or NO₂ and/or NOₓ in the gas, are provided in device 1 for determination of the NH₃ content of a gas, where the gas being measured flows through the device and a converter 9 for catalytic conversion of NH₃ to NOₓ is arranged in the direction of flow of the gas stream 4 in front of the second electrochemical gas sensor 3, while the first electrochemical gas sensor 2 is brought into contact with the unaltered gas.

1.-16. (canceled)

17. A device for determination of the NH₃ content in a gas, with at least two electrochemical gas sensors (2, 3), which each are sensitive to at least one of NO, NO₂ and NOₓ, and with a converter (9), which supports the oxidation of NH₃ to at least one of NO and NO₂, where one of the electrochemical gas sensors (2) is brought into direct contact with a portion of the gas and the other electrochemical gas sensor (3) is brought into contact with a portion of the gas, which has passed the converter (9).

18. A device as in claim 17, characterized by the fact that the electrochemical gas sensors (2, 3) have an amperometric cell.

19. A device as in claim 17, characterized by the fact that the electrochemical gas sensors (2, 3) have a liquid electrolyte.

20. A device as in claim 17, characterized by the fact that the electrochemical gas sensors (2, 3) have a solid electrolyte.

21. A device as in claim 17, characterized by the fact that the electrochemical gas sensors (2, 3) are identically made.

22. A device as in claim 17, characterized by the fact that the gas is conducted to the gas sensors (2, 3) as a measurement gas stream (4, 6, 7).

23. A device as in claim 17, characterized by the fact that the gas sensors (2, 3) are arranged in succession in the gas stream (4), and the converter (9) is arranged between the gas sensors (2, 3).

24. A device as in claim 17, characterized by the fact that the gas stream (4) is divided into at least two partial streams (6, 7) and one of the gas sensors (2, 3) is arranged in each partial stream (6, 7), where the converter is arranged in front of the gas sensor (3) in one partial stream (7) in the direction of flow.

25. A device as in claim 17, characterized by the fact that the converter (9) has a semiconductor material.

26. A device as in claim 17, characterized by the fact that the converter (9) can be heated to a predetermined constant temperature.

27. A device as in claim 26, characterized by the fact that the predetermined temperature lies between 300 and 700° C.

28. A device as in claim 17, characterized by the fact that the converter (9) contains Pt, Pd, Rh or another metal of the platinum group.

29. A device as in claim 17, characterized by the fact that the device (1) is made portable.

30. A device as in claim 17, characterized by the fact that the device (1) is made as a hand-held device.

31. A device as in claim 17, characterized by the fact that a pump is provided to drive the stream of gas that is being measured.

32. A device as in claim 17, characterized by the fact that each gas sensor (2, 3) has a first electrochemical sensor element (10, 11) that is sensitive for NO, and a second electrochemical sensor element (12, 13) that is sensitive for NO₂.

33. A device as in claim 17, characterized by the fact that each gas sensor (2, 3) has an electrochemical sensor element in which an electrochemical sensor element (10, 11) that is sensitive for NO and an electrochemical sensor element (12, 13) that is sensitive for NO₂ are integrated.

34. A device as in claim 17, characterized by the fact that the first electrochemical sensor element (10, 11) is arranged in front of the second electrochemical sensor element (12, 13) in the direction of flow of the stream of gas being measured (4).
